(19) United States
(12) Patent Application Publication
(10) Pub. No.: US 2024/0148093 A1
(43) Pub. Date: May 9, 2024

(54) Hat With Battery Charger System And Method

(71) Applicant: Glenn Mexico, Marlette, MI (US)

(72) Inventor: Glenn Mexico, Marlette, MI (US)

(21) Appl. No.: 17/983,228

(22) Filed: Nov. 8, 2022

(51) Int. Cl. A42B 1/006; H02J 7/00; H02J 7/35

(52) U.S. Cl. CPC A42B 1/006; H02J 7/0042; H02J 7/35; H02J 2300/24

(57) ABSTRACT

A hat with battery charger system and method for using solar panels attached to a baseball hat includes a baseball hat including a crown removably abutting a forehead of a user. A brim is attached to the crown and a universal serial bus port is coupled to the baseball hat receives a universal serial bus plug of a charging cord for an electronic device. A crown solar panel is attached to the crown of the baseball hat and is electrically coupled to the universal serial bus port. A brim solar panel is attached to the brim of the baseball hat and is electrically coupled to the universal serial bus port.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to battery charger systems and more particularly pertains to a new battery charger system for using solar panels attached to a baseball hat.

### (2) Description of Related Art Including Information Disclosed Under 37 CFR 1.97 and 1.98

The prior art relates to battery charger systems and includes a variety of battery charger systems receiving electricity from solar panels attached to a baseball hat. Known prior art does not include a battery charger system including a universal serial bus port for receiving a universal serial bus plug of a charging cord.

### BRIEF SUMMARY OF THE INVENTION

An embodiment of the disclosure meets the needs presented above by generally comprising a baseball hat including a crown configured for removably abutting a forehead of a user. A brim is attached to the crown and a universal serial bus port is coupled to the baseball hat and is configured for receiving a universal serial bus plug of a charging cord for an electronic device. A crown solar panel is attached to the crown of the baseball hat and is electrically coupled to the universal serial bus port. A brim solar panel is attached to the brim of the baseball hat and is electrically coupled to the universal serial bus port.

Another embodiment of the disclosure comprises a method of inserting a head of a user within a head space of a baseball hat and engaging with a closure of the baseball hat to secure the baseball hat to the head of the user. A universal serial bus plug of a charging cord for an electronic device is inserted into a universal serial bus port and a crown solar panel is positioned within sunlight wherein the crown solar panel provides electric power to the charging cord.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a hat with battery charger system and method according to an embodiment of the disclosure.

FIG. 2 is a front view of an embodiment of the disclosure.

FIG. 3 is a back view of an embodiment of the disclosure.

FIG. 4 is an in-use view of an embodiment of the disclosure.

FIG. 5 is an exploded in-use view of an embodiment of the disclosure.

### DETAILED DESCRIPTION OF THE INVENTION

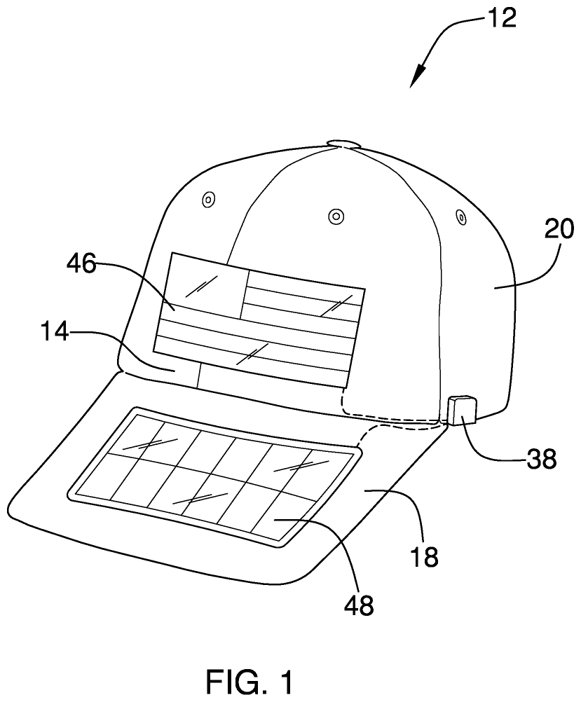

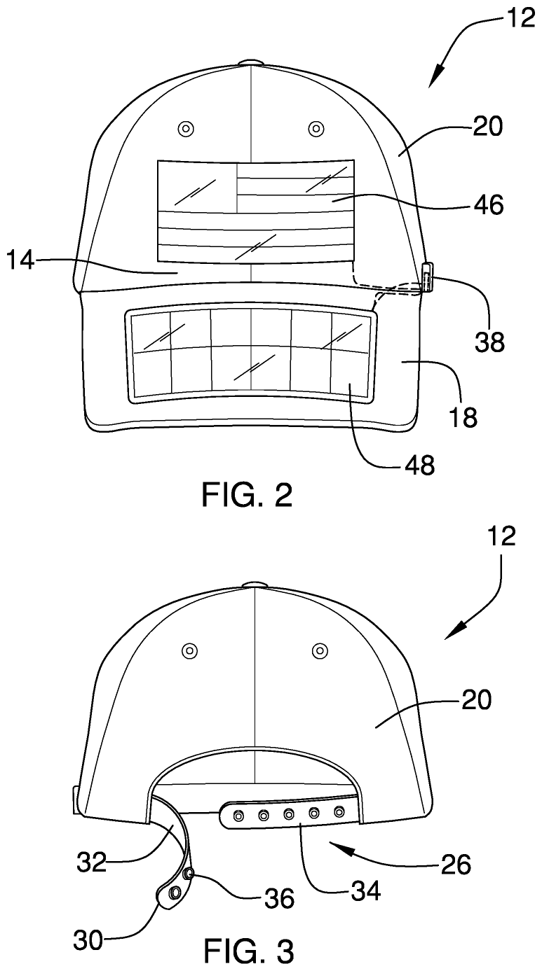

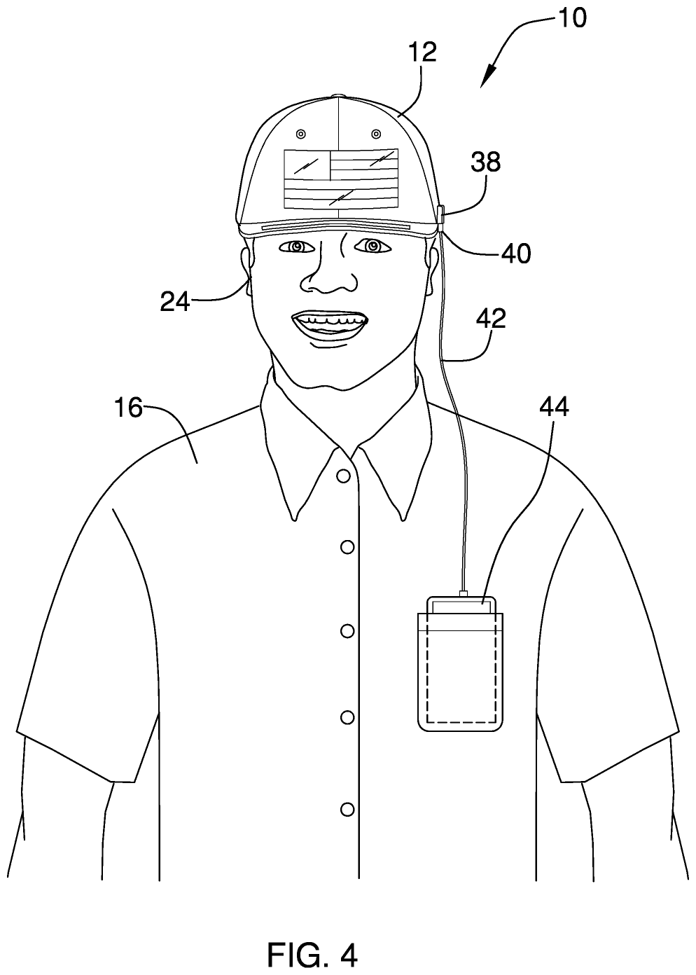

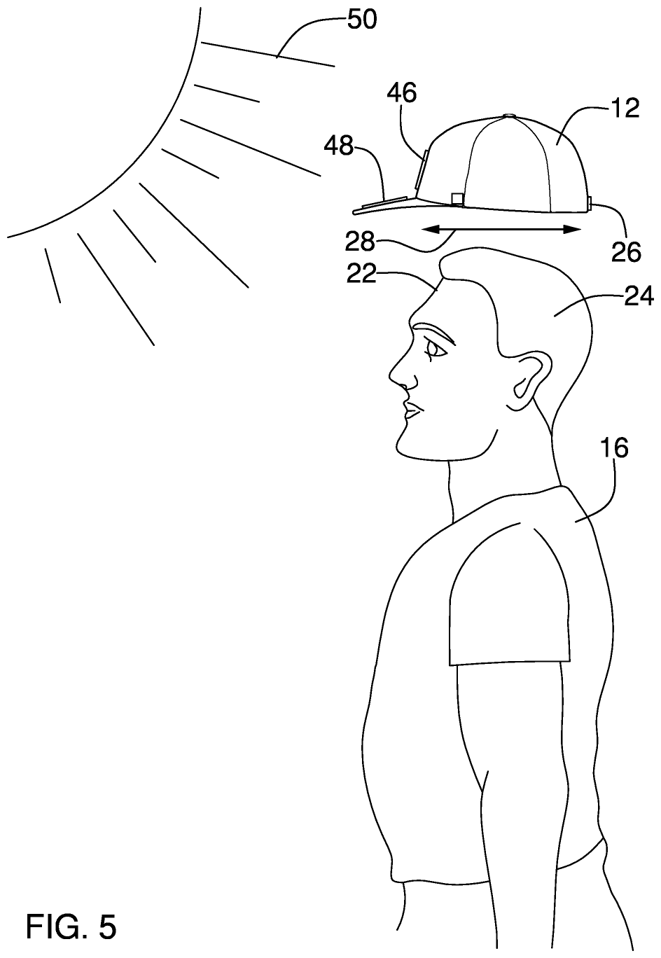

With reference now to the drawings, and in particular to FIGS. 1 through 5 thereof, a new battery charger system embodying the principles and concepts of an embodiment of the disclosure and generally designated by the reference numeral 10 will be described.

As best illustrated in FIGS. 1 through 5, the hat with battery charger system and method 10 generally comprises a baseball hat 12 including a crown 14 configured for removably abutting a forehead 22 of a user 16. A brim 18 is attached to the crown 14 and a plurality of fabric panels 20 is coupled to the crown 14 and encloses a head space configured for removably receiving a head 24 of the user 16.

A closure 26 is typically coupled to the fabric panels 20 and is configured for adjusting a diameter 28 of the baseball hat 12 wherein the closure secures the baseball hat 12 to the head 24 of the user 16 by tightening the diameter 28 upon the head 24 of the user 16. The closure 26 normally comprises a strap 30 including a first portion 32 and a second portion 34. A coupler 36 removably secures the first 32 and second 34 portions to each other and may comprise a snap button fastener or another conventional closure coupler such as a buckle.

A universal serial bus port 38 is coupled to the baseball hat 12 and is configured for receiving a universal serial bus plug 40 of a charging cord 42 for an electronic device 44. The electronic device 44 may comprise a mobile phone or any portable electronic device being transportable by the user 16. The universal serial bus port 38 may couple to one of the fabric panels 20.

A crown solar panel 46 is attached to the crown 14 of the baseball hat 12 and is electrically coupled to the universal serial bus port 38. The crown solar panel 46 may be a flag design such as a national flag. A brim solar panel 48 is attached to the brim 18 of the baseball hat 12 and is electrically coupled to the universal serial bus port 38 wherein the brim solar panel 48 and the crown solar panel 46 provide electric power to the universal serial bus port 38.

In use, the baseball hat 12 is secured to the head 24 of the user 16 and the universal serial bus plug 40 of the charging cord 42 is inserted into the universal serial bus port 38 of the baseball hat 12. The crown 26 and brim 48 solar panels are positioned in sunlight 50 to provide electric power the electronic device 44 electrically engaged with the charging cord 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hat with a battery charger system comprising:
a baseball hat including a crown configured for removably abutting a forehead of a user;
a brim being attached to said crown;
a universal serial bus port being coupled to said baseball hat and being configured for receiving a universal serial bus plug of a charging cord for an electronic device;
a crown solar panel being attached to said crown of said baseball hat and being electrically coupled to said universal serial bus port; and
a brim solar panel being attached to said brim of said baseball hat and being electrically coupled to said universal serial bus port.

2. The hat with a battery charger system of claim 1, further including a plurality of fabric panels being coupled to said crown and enclosing a head space, said head space being configured for removably receiving a head of the user.

3. The hat with a battery charger system of claim 2, further including a closure being coupled to said fabric panels and being configured for adjusting a diameter of said baseball hat wherein said closure secures said baseball hat to the head of the user.

4. The hat with a battery charger system of claim 3, wherein said closure comprises a strap including a first portion and a second portion, a coupler removably securing said first and second portions to each other, said coupler comprising a snap button fastener.

5. The hat with a battery charger system of claim 2, wherein said universal serial bus port is coupled to one of said fabric panels.

6. The hat with a battery charger system of claim 1, wherein said crown solar panel is a flag design.

7. A hat with a battery charger system comprising:
a baseball hat including a crown configured for removably abutting a forehead of a user;
a brim being attached to said crown;
a plurality of fabric panels being coupled to said crown and enclosing a head space, said head space being configured for removably receiving a head of the user;
a closure being coupled to said fabric panels and being configured for adjusting a diameter of said baseball hat wherein said closure secures said baseball hat to the head of the user, said closure comprising a strap including a first portion and a second portion, a coupler removably securing said first and second portions to each other, said coupler comprising a snap button fastener;
a universal serial bus port being coupled to said baseball hat and being configured for receiving a universal serial bus plug of a charging cord for an electronic device, said universal serial bus port coupling to one of said fabric panels;
a crown solar panel being attached to said crown of said baseball hat and being electrically coupled to said universal serial bus port, said crown solar panel being a flag design; and
a brim solar panel being attached to said brim of said baseball hat and being electrically coupled to said universal serial bus port.

8. A method for using a battery charger attached to a hat including the steps of:
inserting a head of a user within a head space of a baseball hat;
engaging with a closure of said baseball hat to secure said baseball hat to the head of the user;
inserting a universal serial bus plug of a charging cord for an electronic device into a universal serial bus port; and
positioning a crown solar panel within sunlight wherein said crown solar panel provides electric power to said charging cord.

9. The method for using a battery charge attached to a hat of claim 8, further including positioning a brim solar panel within sunlight wherein said brim solar panel provides electric power to said charging cord.
